(19) United States
(12) Patent Application Publication
(10) Pub. No.: US 2023/0303377 A1
(43) Pub. Date: Sep. 28, 2023

(54) A FILLER MACHINE AND METHOD OF USE THEREOF

(71) Applicant: PATENT AGENCIES LIMITED, Auckland (NZ)

(72) Inventors: Anthony William Costello, Tauranga (NZ); Patrick Mills, Urenui (NZ)

(21) Appl. No.: 18/021,278

(22) PCT Filed: Aug. 7, 2021
(86) PCT No.: PCT/NZ2021/050126

§ 371 Date: Feb. 14, 2023

(30) Foreign Application Priority Data
Aug. 14, 2020 (NZ) 767163

(51) Int. Cl. B67C 3/26; B67C 3/10; B67C 7/00; B67B 3/02

(52) U.S. Cl. CPC B67C 3/2634; B67C 3/10; B67C 7/00; B67B 3/02; B67C 2003/2602; B67C 2003/2657

(57) ABSTRACT

The present invention relates to a filler machine and method. The filler machine and method allow efficient filling of containers (e.g., bottles) with liquids, and have particular application to filling containers with liquids while maintaining a low oxygen environment in the filled containers.

### FIELD OF THE INVENTION

The present invention relates to a filler machine and in particular to a filler machine useful for filling containers with liquids such as beverages.

### BACKGROUND

There are many available machines for filling a container (for example, a bottle) with a beverage. Filling containers with carbonated beverages can present particular challenges. During the filling process, the carbonated beverage can foam and can lose some of its carbonation. Loss of carbonation can leave the beverage “flat” and excess foaming can also cause wastage and spillage that needs to be cleaned up.

During filling, it is also common for the container to take on oxygen. This is problematic for carbonated beverages such as beers and soft drinks, and also for non-carbonated beverages such as still wines. As current solutions for this, beers are fobbed (foamed) just before capping to drive out the oxygen in the headspace of the bottle, while chemical oxygen scavengers are added to still wines and other drinks prior to corking/capping the bottle.

Thus, currently available techniques for reducing oxygen content in filled containers involve one or more of: product wastage, chemical additives, operator error, and variability. As such, there is an ongoing need for filler machines and methods that allow improved filling of containers with liquids while minimising oxygen levels in the filled containers.

### SUMMARY OF THE INVENTION

In one aspect, the present invention provides a filler machine comprising:
a sealed chamber which seals off air entry to (i) a container or a container opening, (ii) a cap or other closure for the container, and (iii) a capper or other closure-adding mechanism which introduces the cap or the other closure, respectively, to the container opening, the sealed chamber being connected to a vacuum generating mechanism and a vent valve;
a filler tube which introduces liquid into the container, which is lowered into the container, and which extends through the sealed chamber via sealed entry, wherein (i) prior to filling the container with the liquid, the filler tube is positioned at or proximate the bottom of the container, (ii) during filling, the filler tube lifts while still keeping a bottom end of the filler tube immersed in the liquid, and (iii) on completion of filling, the filler tube is lifted out of the container;
a filler tube lifting assembly which lowers the filler tube into the container and lifts the filler tube during filling; and lifts the filler tube out of the container on completion of filling;
a gas injection tube which runs parallel or essentially parallel to a filler tube, which directs one or more purge gases into the container prior to the liquid being filled into the container, and which is lifted and lowered into the container together with the filler tube;
the vacuum generating mechanism which draws air and the one or more purge gasses out of the container and sealed chamber through a top portion of the sealed chamber prior to the liquid being filled in the container, wherein the vacuum generating mechanism thereby assists with purging of air from the container and the sealed chamber;
a secondary gas injection mechanism which directs one or more secondary gasses into a top portion of the sealed chamber prior to and during the filling of the container with the liquid, wherein the secondary gas injection mechanism thereby restores pressure to the container that is lost during filling of the liquid in the container; and
the vent valve which has an opening in an exit port to control release of pressure from within the container, which in turn controls flow of liquid into the container.

In various aspects:
The container is a bottle.
The bottle is a beer bottle or a wine bottle.
The cap is a crown cap or screw cap.
The liquid is a beverage.
The liquid is a fermented beverage.
The liquid is a carbonated beverage.
The liquid is selected from the group consisting of beers, wines, wine spritzers, ciders, waters, energy drinks, soft drinks, and kombuchas.
The liquid is selected from the group consisting of still wines, sparkling wines, and champagnes.
The liquid is selected from the group consisting of coffees, teas, milks, juices, and waters.
The vacuum generating mechanism is a pneumatic vacuum generator.
The gas injection tube is positioned inside the filler tube.
The gas injection tube is positioned externally to and proximal to the filler tube.
The liquid enters the filler tube through a product port, which is positioned at a top portion of the filler tube.
The one or more purge gases enter the gas injection tube through a gas injection port, which is positioned at a top portion of the gas injection tube.
The one or more purge gases are selected from carbon dioxide, nitrogen, and a combination thereof.
The one or more secondary gases are selected from carbon dioxide, nitrogen, and a combination thereof.
The filler machine further includes a filler tube piston at a top portion of the filler tube.
The filler tube piston controls a filler tube valve which opens and closes at the bottom portion of the filler tube.
The filler machine further includes an indexing handle to transit a filling head assembly from a fill position to a cap/closure position on the filler machine, wherein the filling head assembly allows the container to remain sealed off from air entry during shifting of the container between the fill position and the cap/closure position on the filler machine.
The filler machine further includes a capping/closing assembly to cap or otherwise close the container which has been filled with the liquid, wherein the capping/closing assembly allows for the container to remain sealed off from air entry during capping or otherwise closing of the container.
The filler machine further includes a cap inserter which feeds caps to the capper.
The filler machine further includes a capper handle which is actuated to push the cap onto the container.

In another aspect, the present invention provides a method of filling a container with liquid, the method comprising:
placing a container, or a neck and an opening of the container, into a chamber which seals off air entry to (i) the container or the opening of the container, (ii) a cap or other closure for the container, and (iii) a capper or other closure-adding mechanism which places the cap or the other closure, respectively, onto the opening of the container;
injecting one or more purge gases through a gas injection tube, the gas injection tube being movable in a same direction as a filler tube, and lowering the gas injection tube along with a filler tube into the container, the filler tube and the gas injection tube extending through the chamber, and the filler tube and the gas injection tube being lowered such that a bottom of the filler tube and a bottom of the gas injection tube is positioned at or proximate the bottom of the container;
generating a vacuum to draw air and the one or more purge gasses out of the container and the chamber through an upper portion of the chamber;
pressurising the container and the chamber by injecting one or more secondary gases into the chamber;
commencing filling of the container by transiting the liquid through the filler tube and into the container;
during filling (i) lifting the filler tube while still keeping a bottom end of the filler tube immersed in the liquid, (ii) injecting one or more further secondary gases into a top portion of the chamber to maintain pressure in the container, and (iii) using venting on the chamber to control the filling;
on completion of filling, lifting the filler tube and the gas injection tube out of the container to allow introduction of the cap or other closure to the container.

In various aspects:
The container is a bottle.
The bottle is a beer bottle or a wine bottle.
The cap is a crown cap or screw cap.
The liquid is a beverage.
The liquid is a fermented beverage.
The liquid is a carbonated beverage.
The liquid is selected from the group consisting of beers, wines, wine spritzers, ciders, soft drinks, energy drinks, waters, and kombuchas.
The liquid is selected from the group consisting of still wines, sparkling wines, and champagnes.
The liquid is selected from the group consisting of coffees, teas, milks, juices, and waters.
The gas injection tube is positioned inside the filler tube.
The gas injection tube is positioned externally to and proximal to the filler tube.
The one or more purge gases are selected from carbon dioxide, nitrogen, and a combination thereof.
The one or more secondary gases or the one or more further secondary gases are selected from carbon dioxide, nitrogen, and a combination thereof.
In the pressurising step, the one or more secondary gases are injected through the gas injection tube or a secondary gas port or a combination thereof.
The method further comprises transiting the container which has been filled with the liquid to a position on the machine for capping or otherwise closing the container, wherein the container is still sealed off from air entry while transiting to the position for the capping or the otherwise closing of the container.
The method further comprises capping or otherwise closing the container which has been filled with the liquid, wherein the container is still sealed off from air entry during the capping or the otherwise closing of the container.
The vacuum generation is automated.
The injecting of the one or more purge gasses is automated.
The injecting of the one or more secondary gasses or the one or more further secondary gasses is automated.
The transiting of the container from a filling position to a capping/closure position is automated.
The capping or closure-adding mechanism is automated.

The foregoing brief summary broadly describes the features and technical advantages of certain embodiments of the present invention. Further technical advantages will be described in the detailed description that follows.

Novel features that are believed to be characteristic of the invention will be better understood from the detailed description provided herewith. The figures and exemplifications herein are intended to help illustrate the invention or assist with developing an understanding of the invention, and are not intended to limit the scope of the invention in any way.

### BRIEF DESCRIPTION OF THE DRAWINGS

FIG. 1A: shows a right side view of a filler machine according to an aspect of the present disclosure, with a container positioned at a filling station.

FIG. 1B: shows a cross-sectional view (B-B) of the filler machine shown in FIG. 1A.

FIG. 1C: shows a front view of the filler machine shown in FIG. 1A.

FIG. 2A: shows a front view of the filler machine according to an aspect of the present disclosure, with a container positioned at a filling station.

FIG. 2B: shows a cross-sectional view (B-B) of the filler machine shown in FIG. 2A.

FIG. 3A: shows a right side view of the filler machine according to an aspect of the present disclosure, with a container positioned at a filling station.

FIG. 3B: shows a cross-sectional view (A-A) of the filler machine shown in FIG. 3A.

FIG. 3C: shows a detail view of the circled portion (B) of the filler machine shown in FIG. 3B.

FIG. 4A: shows a right side view of the filler machine according to an aspect of the present disclosure, with a container positioned at a filling station.

FIG. 4B: shows a cross-sectional view (A-A) of the filler machine shown in FIG. 4A.

FIG. 4C: shows a detail view of the circled portion (B) of the filler machine shown in FIG. 4B.

FIG. 5A: shows a right side view of the filler machine according to an aspect of the present disclosure, with a container positioned at a filling station.

FIG. 5B: shows a cross-sectional view (A-A) of the filler machine shown in FIG. 5A.

FIG. 5C: shows a detail view of the circled portion (C) of the filler machine shown in FIG. 5B.

FIG. 5D: shows a detail view of the circled portion (D) of the filler machine shown in FIG. 5B.

FIG. 6A: shows a front/right hand perspective view of the filler machine according to an aspect of the present disclosure, with a container positioned at a filling station.

FIG. 6B: shows a detail view of the circled portion (A) of the filler machine shown in FIG. 6A.

FIG. 7: shows a front/left hand perspective view of the filler machine according to an aspect of the present disclosure, with a container positioned at a filling station.

FIG. 8A: shows a front view of the filler machine according to an aspect of the present disclosure, with a container positioned at a filling station.

FIG. 8B: shows a cross-sectional view (A-A) of the filler machine shown in FIG. 8A.

FIG. 9A: shows a top/right hand perspective view of the filling head assembly according to an aspect of the present disclosure.

FIG. 9B: shows a bottom/left hand perspective view of the filling head assembly shown in FIG. 9A.

FIG. 9C: shows a top plan view of the filling head assembly shown in FIG. 9A.

FIG. 10A: shows a front view of the filler tube lifter assembly according to an aspect of the present disclosure.

FIG. 10B: shows a top/left hand perspective view of the filler tube lifter assembly shown in FIG. 10A.

FIG. 10C: shows a front view of the filler tube lifter assembly shown in FIG. 10A, with shading omitted.

FIG. 10D: shows a top/left hand perspective view of the filler tube lifter assembly shown in FIG. 10A, with shading omitted.

FIG. 11A: shows a front view of the filler machine according to an aspect of the present disclosure, with a container positioned at a capping station.

FIG. 11B: shows a cross-sectional view (A-A) of the filler machine shown in FIG. 11A.

FIG. 11C: shows a detail view of the circled portion (B) of the filler machine shown in FIG. 11B.

FIG. 11D: shows the detail view of FIG. 11C, with shading omitted.

### DETAILED DESCRIPTION OF THE INVENTION

Reference is made to International patent application PCT/NZ2015/050095, which is hereby incorporated by reference herein in its entirely.

The following description sets forth numerous exemplary configurations, parameters, and the like. It should be recognised, however, that such description is not intended as a limitation on the scope of the present invention, but is instead provided as a description of exemplary embodiments.

### Definitions

In each instance herein, in descriptions, embodiments, and examples of the present invention, the terms “comprising”, “including”, etc., are to be read expansively, without limitation. Thus, unless the context clearly requires otherwise, throughout the description and the claims, the words “comprise”, “comprising”, and the like are to be construed in an inclusive sense as to opposed to an exclusive sense, that is to say in the sense of “including but not limited to”.

The directional terms “top”, “bottom”, “upper”, “lower”, “front”, “rear”, “side”, “left”, “right”, as used herein are defined given the viewpoint of a user engaging with the machine.

As used herein, “essentially vertical” encompasses an orientation that is up to 10° out from true vertical. “Essentially parallel” encompasses components that are up to 10° out from parallel. “Essentially inside” encompasses items that are positioned in an enclosed space such that at least 90% of the surface area of the item in question is positioned within the enclosed space.

As used herein, “approximately” means up to 10% greater or up to 10% lesser than a particular value.

As used herein, a “purge gas” is any food grade gas, excluding oxygen. For example, purge gas may be carbon dioxide, nitrogen, or any combination thereof.

### Filler Machine

While exemplifications are provided with reference to filling bottles with beverages, it should be appreciated the filler machine and method of the present disclosure may be used for filling other types or containers, and to fill containers with other types of liquids.

Advantageously, the disclosed filler machine and method allow a container to be filled with a liquid relatively quickly and accurately, while significantly reducing the amount of oxygen that is introduced. Many types of liquids can be damaged by oxidation, and these deleterious effects cannot be reversed. Accordingly, the present machine and methods can be used for filling containers with any liquids that benefit from a low oxygen environment.

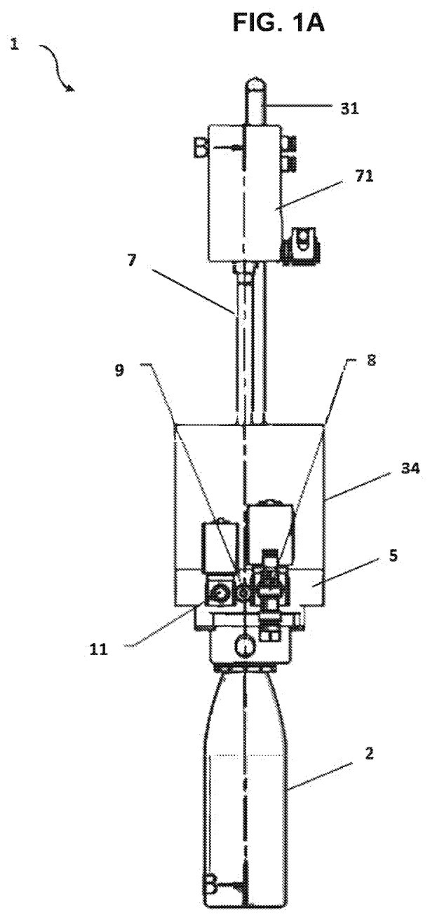

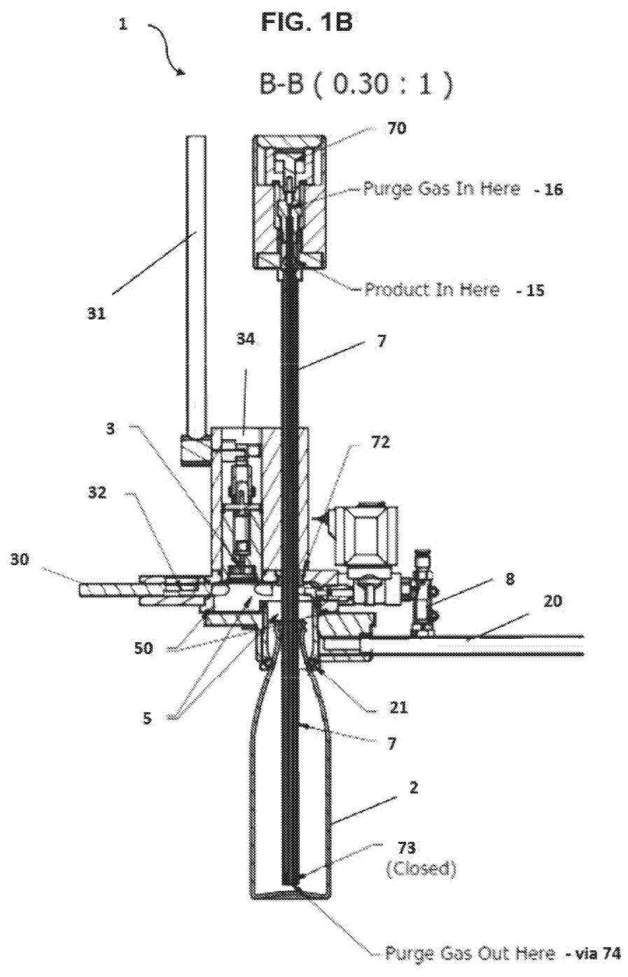

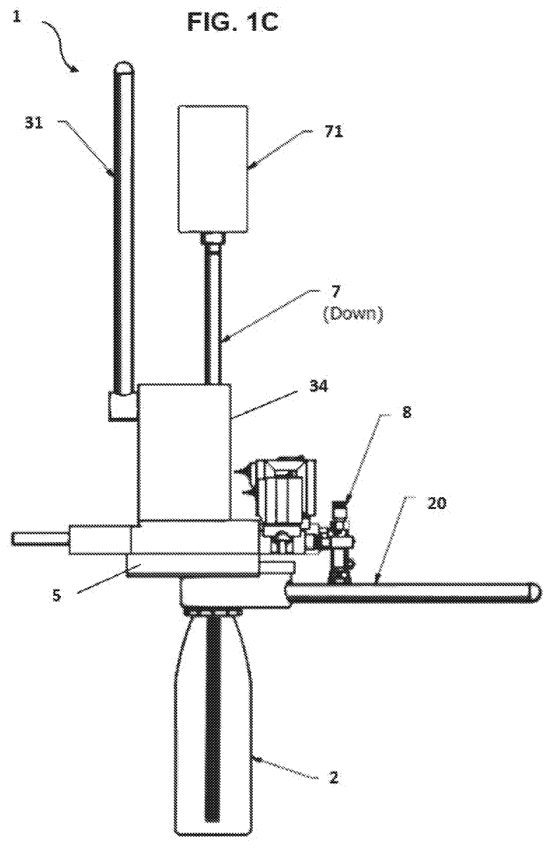

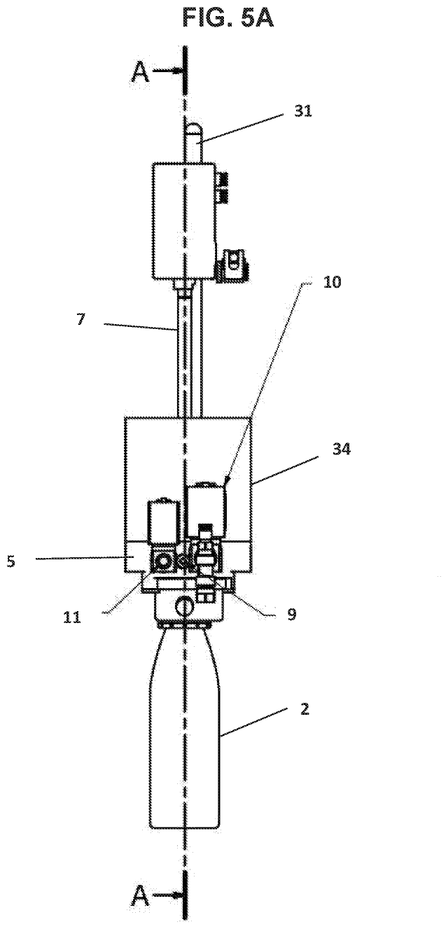

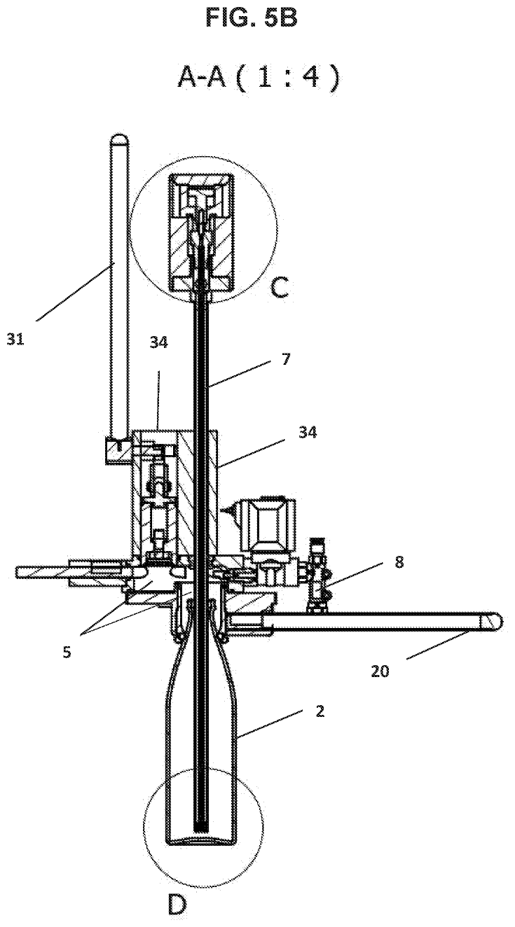

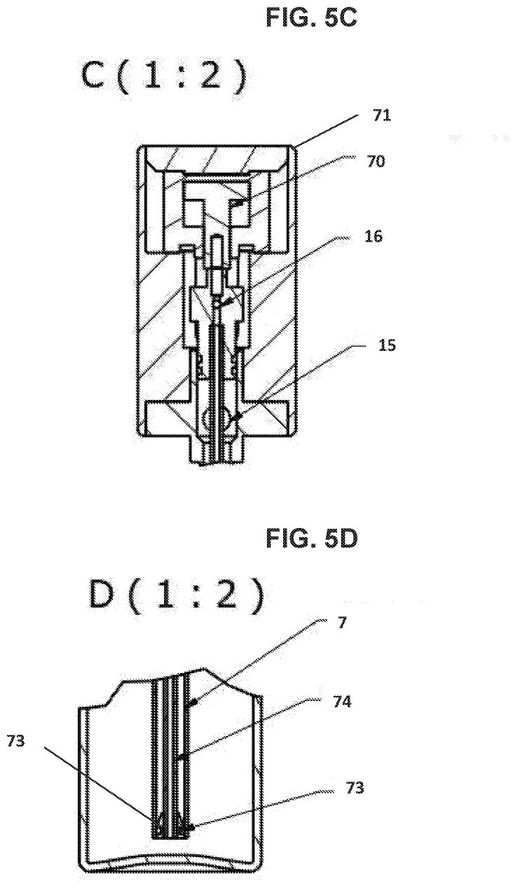

The filler machine includes a filler tube which extends into the container that is to be filled (e.g., a bottle). The filler tube runs vertically or essentially vertically from the filling machine. Prior to initiation of filling, the bottom portion of the filler tube is positioned at the bottom portion of the container. See, e.g., FIGS. 1A-1C. The liquid enters the top portion of the filler tube via a product port. See, e.g., FIGS. 5B and 5C.

At the bottom portion of the filler tube is a filler tube valve. This acts as a liquid control valve. See, e.g., FIG. 5D. The filler tube valve controls release of the liquid into the container (e.g., a bottle). The filler tube valve is set in a closed position prior to filling liquid into the container. See, e.g., FIG. 1B. The filler tube valve can be connected to an operating mechanism at the top of the filler tube (see below).

At the top portion of the filler tube is a filler tube valve controller, i.e., an operating mechanism for the filler tube. The filler tube valve controller controls the opening and closing of the filler tube valve. The filler tube valve controller may be fabricated as a piston. For example, the controller (e.g., piston) can be connected by an arm (e.g., pipe) inside the filler tube, to the filler tube valve, which is proximal to the bottom of the filler tube. When this piston is actuated, it can move the valve and allow liquid out of the filler tube. In one aspect, the filler tube valve controller may be enclosed in a filler tube controller chamber. See, e.g., FIGS. 1A-1C.

Running parallel or approximately parallel to the filler tube is a gas injection tube. Prior to filling the liquid in the container, purge gas/gasses (e.g., carbon dioxide and/or nitrogen) enter at the top portion of the gas injection tube, via a gas injection port. See, e.g., FIG. 1B. For example, purge gas/gasses entry may be controlled as part of a programmed sequence. The present machine and method may be actuated by a starter, e.g., a start button or switch. The purge gas/gasses enter the gas injection tube and exits the bottom portion of the gas injection tube, and into the container (e.g., the bottle). See, e.g., FIG. 5D. The purpose of the purge gas/gasses is to displace the air from the container and from the sealed chamber, such that oxygen levels can be minimised.

In particular aspects, there is a filler tube assembly which includes a gas injection tube that is associated with a filler tube. In certain embodiments, the gas injection tube is positioned within the filler tube, or the gas injection tube may be positioned externally to and proximal to the filler tube. This latter arrangement may be advantageous for use with containers such as cans. It will be understood that, even where the gas injection tube is positioned within the filler tube, the contents of the gas injection tube and the filler injection tube are kept separate in their respective tubing. That is, the gas in the gas injection tube does not intermix with the liquid in the filler tube while the gas and liquid are each in their respective tubes. As one specific example, the gas injection tube may be centralised within the filler tube. See, e.g., FIGS. 1B and 5D. In another specific example, the filler tube valve may be a pipe having a hollow rod (gas injection tube) running through the pipe. The liquid can thereby transit through the filler tube (e.g., pipe), while the one or more purge gases can transit through the gas injection tube (e.g., hollow rod). The gas injection tube can be affixed (e.g., welded) to the filler tube controller (e.g., piston) at the top portion of the filler tube. This controller can then activate the filler tube valve to allow product to come out of the filler tube.

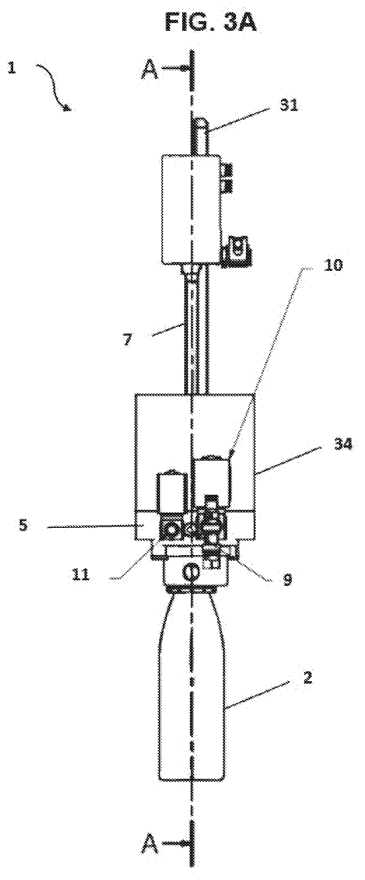

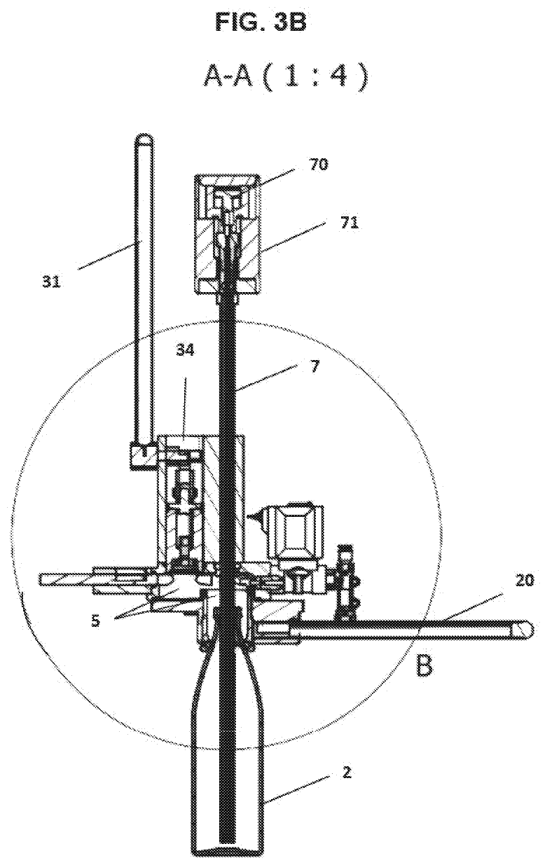

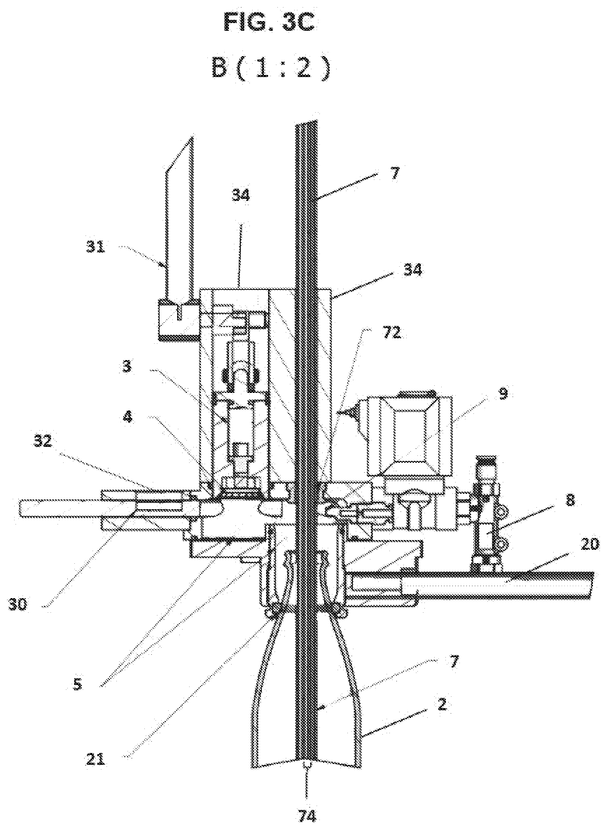

The filler machine includes a mechanism for generating a vacuum. The vacuum generating mechanism may be, for example, a pneumatic vacuum generator, or more specifically, a Venturi pneumatic vacuum generator. See, e.g., FIGS. 1B and 3C. The vacuum generating mechanism is adapted to extract air and any introduced gas/gasses out of the container and chamber, through the upper portion of the sealed chamber. In a particular aspect, the vacuum generating mechanism is used to assist in gas flow but does not necessarily reduce the pressure in the sealed chamber. Nor does the vacuum generating mechanism necessarily reduce the pressure below that of atmospheric pressure. In certain aspects, the pressure in the sealed chamber will increase during the disclosed method.

The filler machine includes a secondary gas injection port. This secondary gas injection port allows introduction of further purge gas/gasses in the top of the chamber. See, e.g., FIG. 3C. This introduction can take place prior to filling and/or during filling. Such introduction can provide gas counter-pressure to keep the dissolved carbon dioxide in the liquid. Thus, the primary gas injection and secondary gas injection may both be used to pressurise the container. This injection restores pressure that has been reduced by the vacuum generating mechanism.

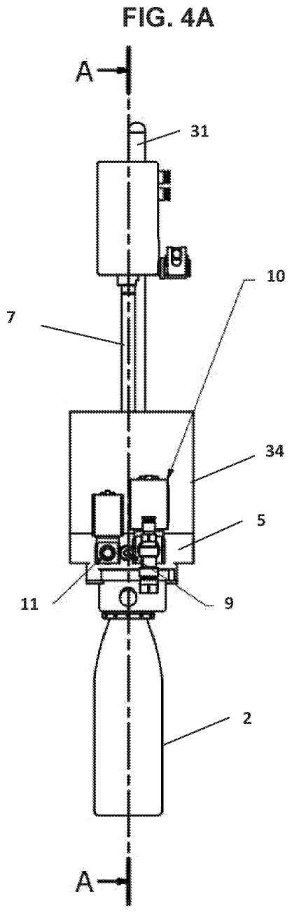

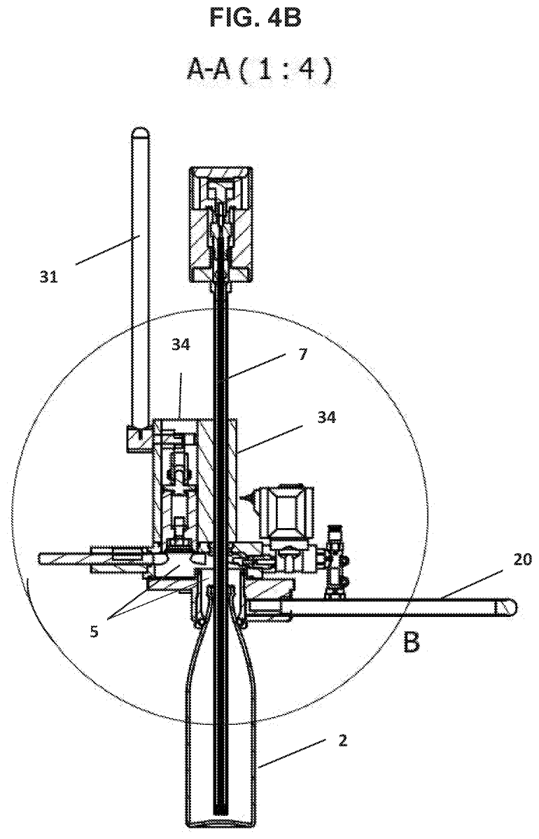

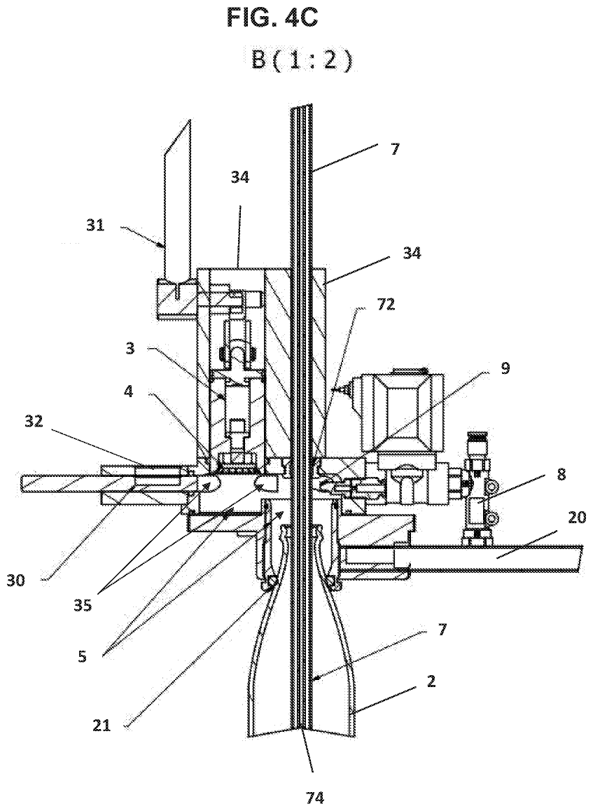

The filler machine includes a vacuum valve and further includes a vent valve. See, e.g., FIG. 4A. The vacuum valve (e.g., a solenoid valve) controls the vacuum flow by the vacuum generating mechanism. The vent valve controls release of pressure from within the container (e.g., the bottle). The vent valve thereby allows the flow of liquid into the container to be controlled. By maintaining sufficiently elevated pressure in the container, this can be used to completely inhibit foam formation or to manage foam levels during filling. For example, the vent valve allows the fill to start slowly and then get faster as the gas pressure within the container reduces. It can also stop the release of gas pressure below a certain level so that foam does not form. The vent valve may be an “off the shelf” valve with a fixed or variable aperture on its exit port to govern the speed of gas release.

In one particular aspect, the vent valve can include a small, fixed opening on the exit port of the vent valve to control the pressure in both the container and the sealed chamber during the filling. This ensures that carbonated liquid cannot foam during the fill and it also governs the filling speed. During standard filling processes, the filling pressure will tend to drop lower than the original pressure. For example, the filling pressure may start at approximately 20 psi and may reduce during filling. The present filling machine, and particular, the vent valve, can be used to retain pressure. It is also possible to restore the pressure to the original container pressure. For example, it is possible to keep the container pressure at or above the original carbonation pressure of the liquid. This is the original carbonation pressure set at the time of manufacture and the temperature of the liquid.

The opening of the vent valve can be varied both in size and shape. It is possible to incorporate a vent valve with a smaller sized opening where increased pressure levels are desired, or to incorporate a vent valve with a larger sized opening where reduced pressure levels are desired. It is also possible to utilise multiple vent valves with different sized openings, and thereby manipulate pressure levels, for example, at different points in the filling process. As an exemplification, the opening of the vent valve can be made by drilling a hole into the exit port, e.g., drilled into the plug of an “off the shelf” valve. The opening may be, for example, approximately 0.5 mm to approximately 1 mm in diameter, approximately 0.75 mm to approximately 1.5 mm in diameter, or approximately 1 mm to approximately 2 mm in diameter, or in particular, the opening may be approximately 1 mm in diameter.

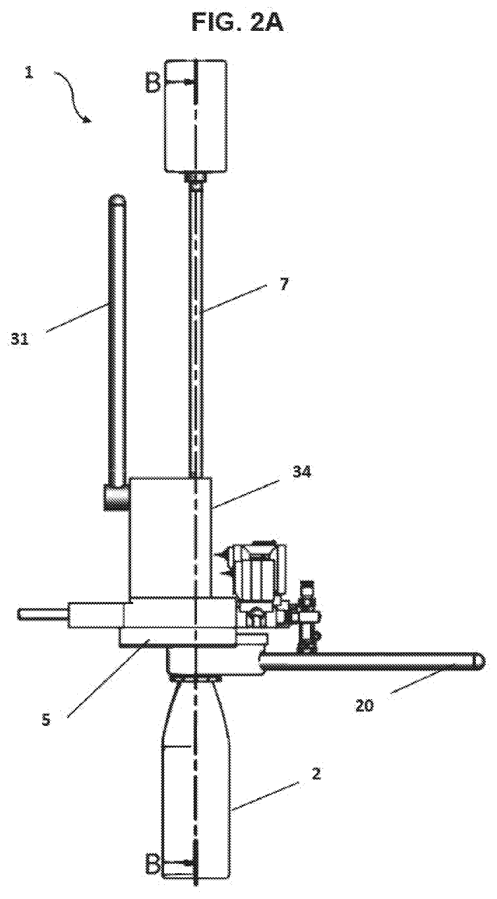

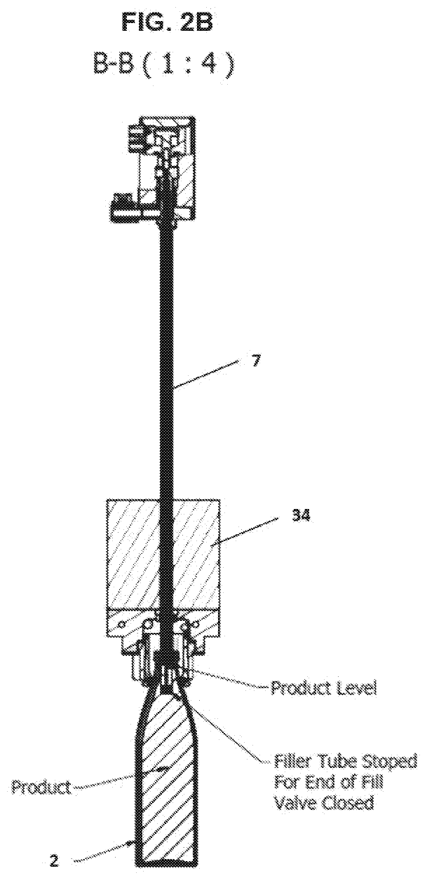

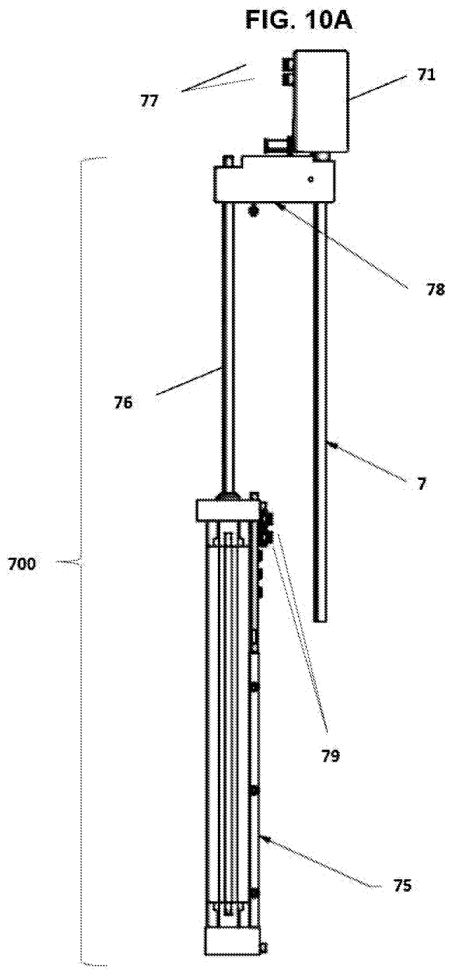

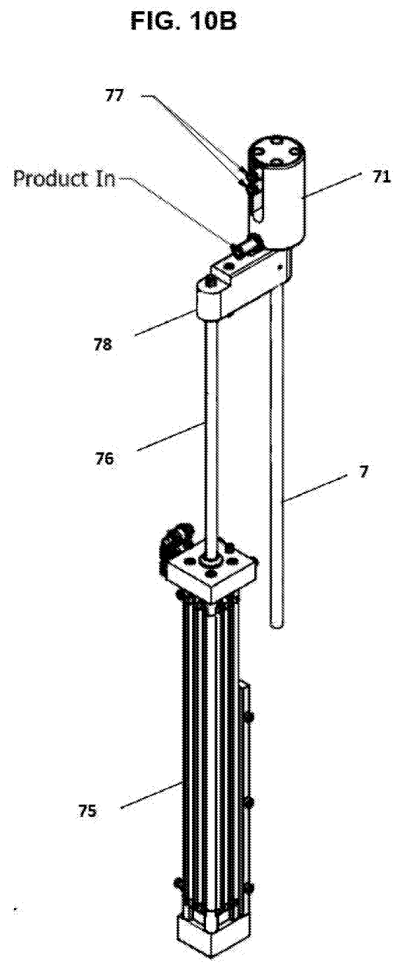

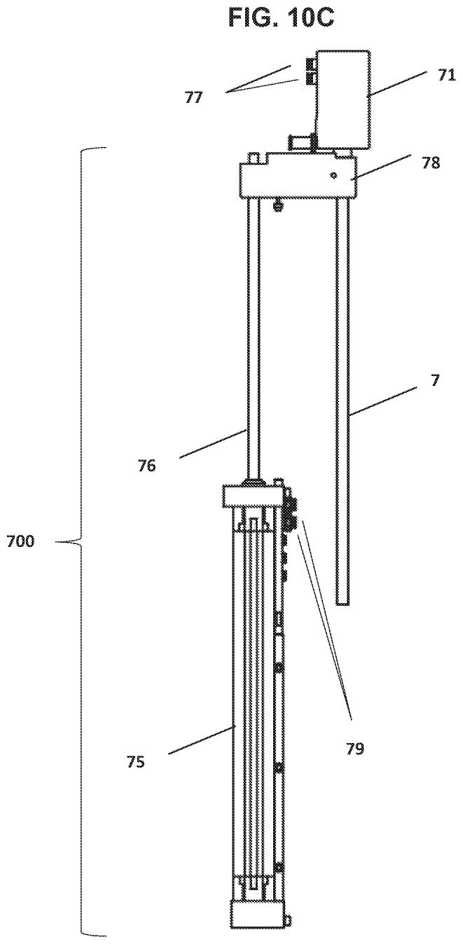

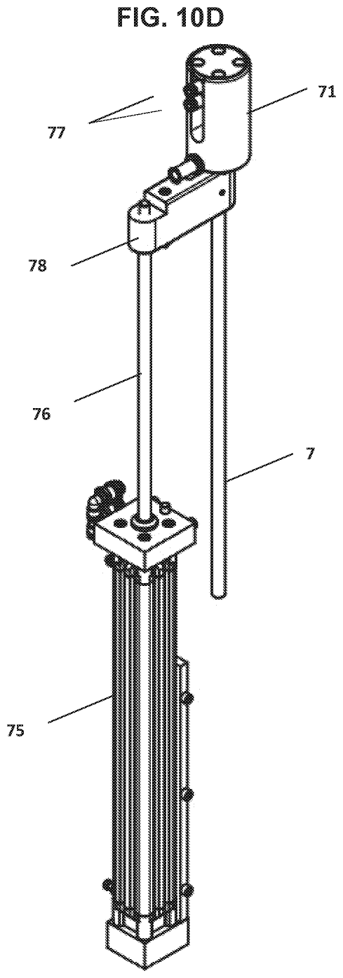

Notably, as liquid filling of the container commences, the filler tube is lifted upwards. See, e.g., position of filler tube in FIGS. 1B and 2B. However, the filler machine is adapted to ensure that the filler tube stays under the level of the liquid the entire time the container is filling. This minimises introduction of air/oxygen into the container, as described in more detail below. The lifting and lowering of the filler tube is actuated by a filler tube lifter assembly. The filler tube lifter assembly includes a mechanism for generating lift, e.g., a pneumatic cylinder. The filler tube lifter is engaged with the filler tube via one or more connections. For example, the filler tube lifter (e.g., pneumatic cylinder) may be engaged with a lifting arm, which runs vertical or essentially vertical out of the lifter. The lifting arm, in turn, can be engaged with a horizontal or essentially horizontal connecting arm, which ultimately engages with the filling tube. See, e.g., FIGS. 10A-10D.

In one aspect, valving may be used to control the lifting mechanism. For example, a standard five port, three position pneumatic valve may be used. In the first position, the pneumatic cylinder rod is driven out. In the third position, the pneumatic cylinder rod is driven in. In the middle position, the air is trapped on both sides of the pneumatic cylinder's piston and this locks the piston in place. In this way, the lifting and lowering of the filler tube may be actuated. In other aspects, an electric-drive linear actuator may be used as the mechanism for generating lift. Those skilled in the art will be well versed in pneumatic cylinders and circuitry and electric-drive linear actuators, and will be able to adapt and apply these mechanisms, accordingly.

The filler machine includes an area for introducing caps or other closures to the container (e.g., capping/closure station). In one key aspect, the machine provides a sealed chamber for introducing the caps or other closures to the container. For example, a sealed chamber including a capping station may be provided. See, e.g., FIG. 3C. In particular, the capper, the inserted cap, and the top portion of the container (e.g., the neck and head of a bottle) may be included in a sealed chamber. The sealed chamber is closed off by multiple seals. Positioned above and proximate to where the filler tube enters the top portion of the container (e.g., the mouth of a bottle), there is a filler tube seal. Positioned at the top portion of the container (e.g., the neck of a bottle), there is a neck seal. Positioned on the sides of the chamber, there are chamber seals. Positioned proximate to the cap inserter is a cap inserter seal. See, e.g., FIGS. 1B, 3C, and 8B.

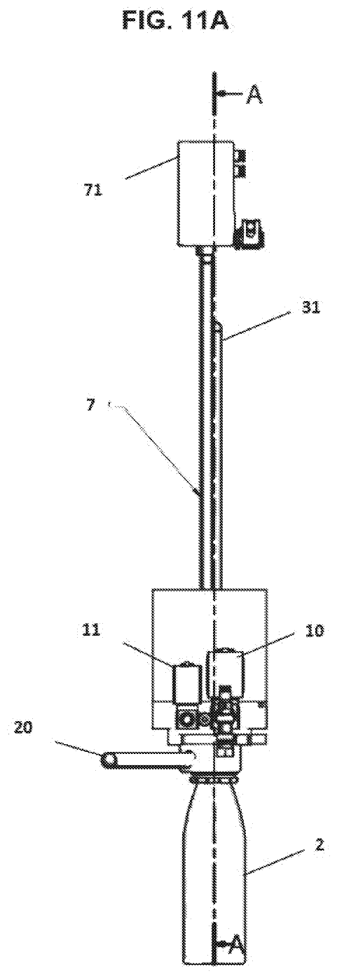

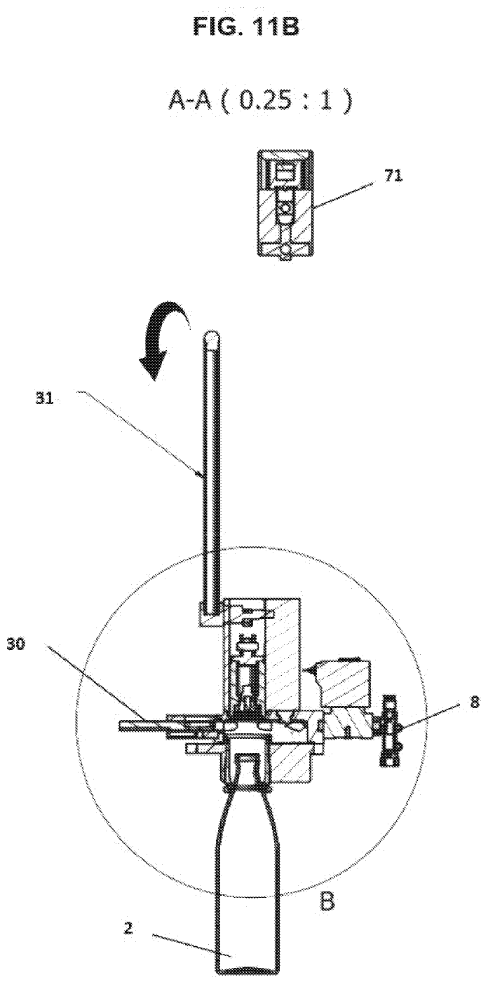

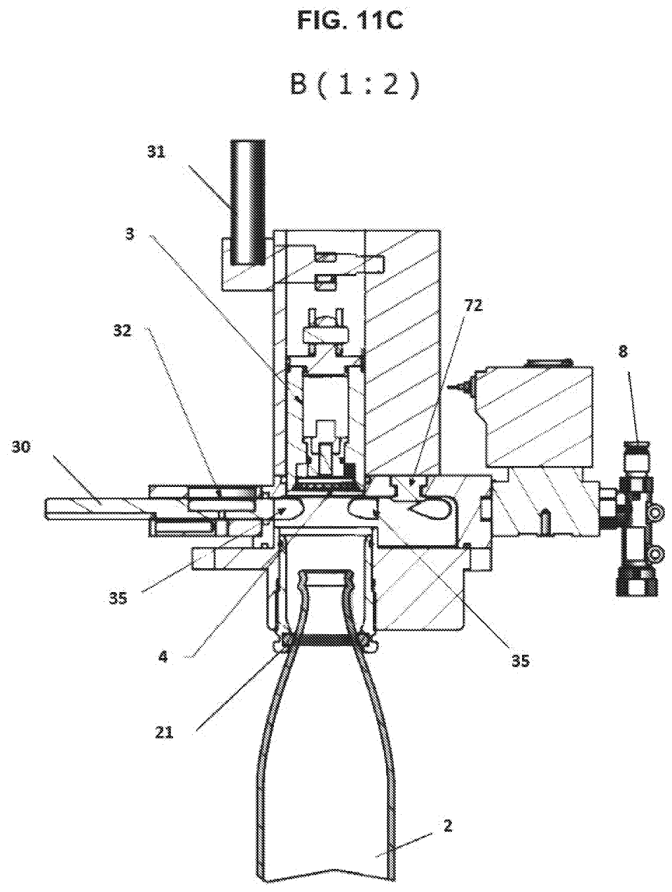

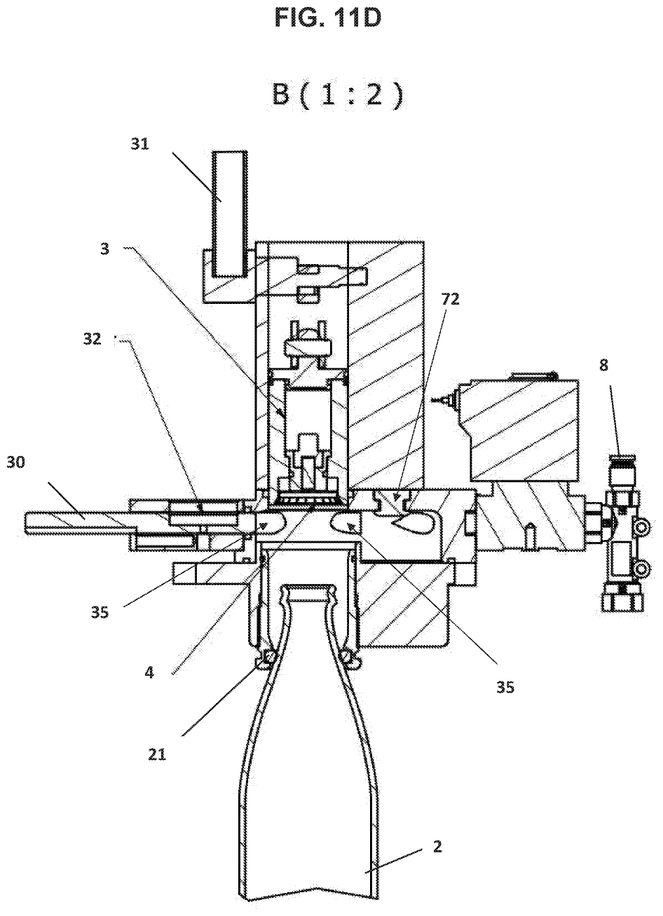

The filler machine includes a mechanism for providing caps or other closures to the machine. In one aspect, the machine can allow for one or more caps to be fed to the capper. For example, a cap can be placed into a cap insert hole. Then, the cap inserter can be pushed towards the capper, thereby feeding the cap to the capper. See, e.g., FIGS. 1B, 3C, 4C, and 7. The filler machine further includes a mechanism for introducing a cap or other closure onto the top of the container (e.g., pressing a cap onto a bottle). For example, a capper handle on the machine can be pulled towards the user to actuate capping of the container. See, e.g., FIG. 11B. In other aspects, automated systems may be used for feeding caps or other closures to the machine and/or to press caps or other closures onto the containers. For example, an automated system may include additional sealed chambers. These may be used to pre-condition caps or other closures, or the mechanism that applies the caps/closures, with purge gases prior to being introduced to the sealed chamber that includes the container or the container opening.

Importantly, the container is sealed off from air entry during the filling and capping/closing process. The filler machine thereby includes a mechanism for indexing the container (e.g., a bottle) between the filling position and the capping/closing position, while still excluding air from the container. Notably, the container and the neck seal and its assembly are able to transition together (e.g., rotate) from the filling area to the capping/closure area of the machine, thereby maintaining the pressure in the container. As such, the continued sealing of the sealed chamber is maintained between filling and capping/closing positions, and air is prevented from reaching the container when transitioning between the filling and the capping/closure stations.

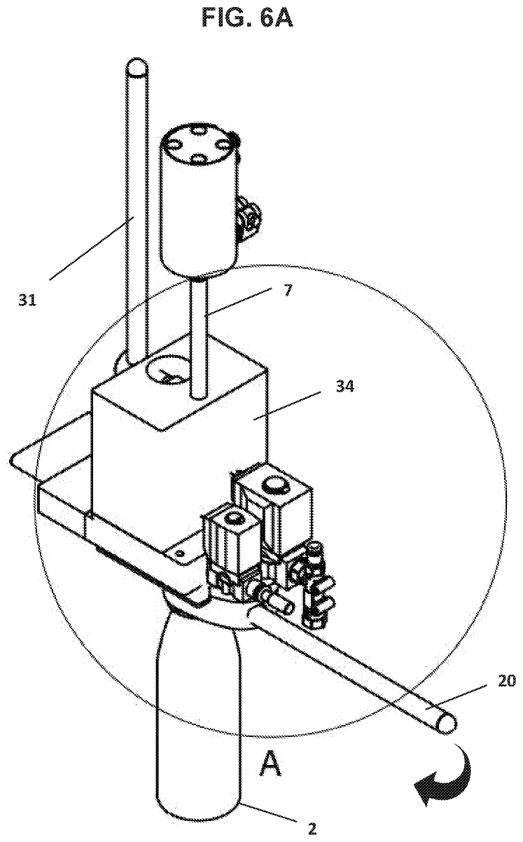

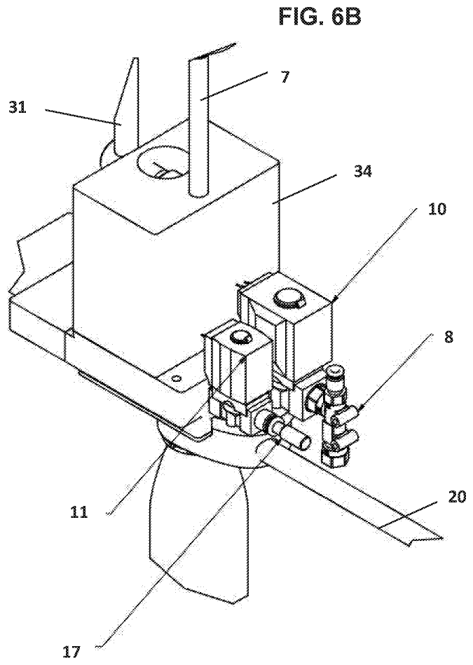

In one aspect, the filler machine includes a filling head assembly. The filling head assembly can include the neck seal for the container and a top seal that connects the assembly to the sealed chamber. The assembly can be moved (e.g., rotated) between the fill position and the capping/closure position on the machine. It is possible, for example, to rotate the filling head assembly on the sealed chamber, such that movement between filling and capping/closing positions is possible without allowing ingress of air to the container. In a particular example, the machine may include a container indexing handle to shift the container between the filling and capping/closure stations. See, e.g., FIGS. 1B and 1C. For example, after filling is completed, the indexing handle can be pulled leftwards to move the container from the filling station to the capping/closure station. See, e.g., FIG. 6A. Then, after capping/closing is completed, the indexing handle can be pulled rightwards to move the container back to the filling station, and the container can be removed. In other aspects, automated systems may be used for shifting containers between filling and capping/closure stations.

### Filling Method

As described herein, the present machine and methods can be used for filling containers with liquids requiring a low oxygen environment. For the purpose of illustration, various aspects of the present method are set out as follows. This includes exemplary as well as optional aspects.
(1) The container (e.g., a bottle or can) is placed into the machine.
(2) The cap/closure is placed into machine.
(3) The starter is actuated, for example, a start button is pressed.
(4a) The purge gas/gasses (e.g., carbon dioxide and/or nitrogen) start to flow through the gas injection tube, for example, at the centre of the filler tube.
(4b) The filler tube starts to move down toward the bottom of the container.
(4c) The vacuum generating mechanism starts to extract the gas from the top of the sealed chamber, this chamber containing the capper, the inserted cap, and the top portion of the container.
(5) The gas purging continues and then the vacuum generating mechanism turns off.
(6) The pressure in both the container and the sealed chamber now starts to rise from the bottom of the container.
(7) Further purge gas/gasses are added through the secondary gas valve in the top of the sealed chamber.
(8) Once the required pressure (e.g., 20 psi) has been reached in the sealed chamber and container, the gas is turned off.
(9a) The filler tube valve at the bottom of the filler tube now opens.
(9b) The vent valve also opens.

(10) During the filling, the filler tube rises. As the liquid gets near the end of the fill and the filling tube is well up into the top portion (e.g., neck) of the container, further gas/gasses are introduced through the secondary gas injection port in the top of the sealed chamber.
(11) At the end of the fill, the filler tube momentarily pauses so the filler tube is still under the liquid at the top of the container.
(12) The filling tube valve and the vent valves are now closed.
(13) The filler tube lifts all the way up.
(14) The container can now be indexed to the capping station and the container can be capped/closed.

(15) The capped/closed container can now be indexed back to the filling position and removed.

In particular aspects, the filler machine and methods of this disclosure may be used in conjunction with various beverages. Both carbonated and non-carbonated beverages are encompassed. This includes fermented beverages such as beers, e.g., craft beers, shandies, radlers, beer-wine hybrids, as well as wines, e.g., sparkling wines, still wines, wine spritzers, champagnes, and other drinks, e.g., ciders, kombuchas, and the like. Further included are non-fermented beverages such as various waters, e.g., tonic waters, sparkling waters, mineral waters, spring waters, club sodas, soft drinks, energy drinks, and the like. Included also are non-fermented, non-carbonated beverages such as milks, coffees, teas, juices, and waters (e.g., still waters).

As specific examples, the filler machine and methods of this disclosure may be used to obtain capped/closed containers filled with liquids comprising less than 50 ppb, less than 45 ppb, less than 40 ppb, less than 35 ppb, less than 30 ppb, less than 25 ppb, less than 20 ppb, less than 15 ppb, or less than 10 ppb oxygen. This oxygen level includes any headspace gas that is in the top of the container.

While crown caps are shown in the accompanying drawings, the filler machine and method described herein may be adapted to allow use of various types of caps and other closures that provide a seal to keep out air. This includes, for example, screw caps, sports drink caps/squirt caps, flip-top caps/swing-top caps, easy pull bottle caps, and pull-off bottle caps. Also useful with the disclosed machine and method are seamed closures (e.g., for cans), snap-on closures, friction fit closures, tamper-evident closures, child-resistant closure, sand dispensing closures, as well as other closures, such as lids, tabs, and stoppers (e.g., cork or glass). These caps and other closures may be comprised of metal materials, glass materials, cork materials, plastic materials, or any combination thereof.

It is a noted aspect of the present method that flow of the purge gas/gasses (e.g., carbon dioxide and/or nitrogen) through the filler machine is facilitated by the vacuum generating mechanism and the secondary gas injection. Used in this way, the vacuum generating mechanism does not necessarily reduce pressure in the sealed chamber, but rather assists with gas flow through the chamber. As examples, the vacuum generating mechanism may assist with purging for approximately 2 to 10 seconds, depending on container size, gas injection tube size, and gas pressure. The vacuum generating mechanism also allows the use of smaller valves as indicated below. The secondary gas injection is further provided to assist with gas flow through the chamber. The secondary gas injection can be used to enhance purging. It can also assist after the vent valve is closed by raising the pressure in the sealed chamber back up to the initial pressure, thus slowing the final fill. The gas/gasses used in the secondary gas injection may be the same as those used for purging, i.e., one or more purge gasses, as described herein.

In the accompanying drawings, a simple pneumatic vacuum generator is shown. It is also possible to generate a vacuum using more sophisticated vacuum systems. Pressure in the sealed chamber can be, for example, approximately 15 psi to approximately 25 psi, approximately 18 psi to approximately 22 psi, or approximately psi. When the gas pressure is at these lower levels it moves slowly through the ported gas valves and tubes. Notably, the present machine and method employing vacuum generation allows use of smaller ported gas valves and tubing. This means that lower levels of purge gas/gasses are required.

In particular aspects, the sealed chamber and container are evacuated by the vacuum after addition of the purge gas/gasses. This allows more efficient reduction of oxygen levels. In specific aspects, the purged gas is initially introduced to the bottom portion of the container. This allows more efficient reduction of oxygen levels and allows lower levels of purge gas/gasses to be used.

During the liquid filling of the container, the filler tube rises. For example, this can be mediated by pressure changes, e.g., via a pneumatic cylinder. The lifting of the filler tube during filling may be automated, e.g., pneumatic components controlled via a program logic control (PLC) system. More details of the filler tube lifting mechanism are provided below. As the liquid gets near the end of the fill and the filling tube is well up into the top portion of the container (e.g., neck of the bottle) additional gas/gasses (e.g., carbon dioxide and/or nitrogen) is introduced through the secondary gas injection port in the top portion of the sealed chamber and allows for the pressure in the container to be restored. For example, if the pressure drops below 18 psi during filling (e.g., dropping to approximately 12 psi), pressure may be restored to approximately 18 psi. This, in turn, means that the filling speed is slowed and the stability of the liquid is enhanced. As an option, it may be advantageous to keep open the vent valve during this time to further assist with gas purging.

As noted above, the filler tube can be momentarily paused at the end of filling such that the filler tube is still under the liquid at the top of the container. This pause may be short (e.g., milliseconds) to allow time for the filling tube valve to close. It could be done “on the fly”. That is, the closure of the filling tube valve could happen a set filling height or set filing time without a pausing or a stoppage taking place. As noted herein, the position of the filler tube can be controlled by the lifting mechanism. For example, this mechanism may include a pneumatic cylinder that is controlled by valving, e.g., a three-position and a five-port valve. However, other means of control are also possible.

It will be understood that, rather than raising and lowering the filler tube/gas injection tube relative to the container, it would be possible to raise or lower the container (using a fixed height filler tube/gas injection tube) such that the same effect is achieved. For example, the container can be elevated until the filler tube/gas injection tube is inside and at or proximate to the bottom of the container. In this arrangement, the container could then be lowered to accommodate the rising fill level/filler tube displacement.

In various aspects, the secondary gas supply may be strategically placed in the sealed chamber to ensure there are no cavities that can trap air/oxygen. For example, it is possible to position gas injection around the chamber closure mechanism. Notably, the secondary gas injection can be used to achieve sufficient pressure in the sealed chamber, for example, approximately 15 psi to approximately 25 psi, approximately 18 psi to approximately 22 psi, or approximately 20 psi.

As key features of the present machine and method: the sealed chamber, which includes a seal around the upper portion of the container (e.g., neck seal), is used to keep air from entering the container during filling and also during capping/closing of the container; the container is filled starting with the filler tube bottom portion of the container, and during filling, the filler tube is kept under the surface of the liquid; due to the continued sealing of the sealed chamber, the pressure in the container is maintained while transiting between the filling station and the capping/closing station, and also during the capping/closing of the container; pressure is only released (air entry allowed) after capping/closing of the container and its removal from the machine. Notably, because the machine preconditions the atmosphere in the container and around the cap/closure, the oxygen level is minimised. Container pressure is maintained above liquid carbonation pressure so that the carbonation does not come out of solution before capping/closure of the container (e.g., as occurs with the foaming or fobbing of beer).

In certain aspects, the present machine and method may include the use of additional sealed chambers. Such chambers could allow for additional caps/closures, additional capping/closure mechanisms, individual containers, multiple containers, etc. to be evacuated or pre-conditioned with purge gases prior to entering the main sealed chamber. This would allow maximising of throughput speed and minimising of oxygen levels.

In alternative aspects, the whole container can be placed inside the sealed chamber. For example, thin walled containers such as aluminium cans or plastic bottles could be placed inside or essentially inside the sealed chamber. This arrangement would allow the balancing pressure on the inside and outside of the container, thereby stabilising the container in the machine. For example, the whole can, or whole bottle, could be placed into the sealed chamber along with the seaming heads (for the can), or the capper (for the bottle). In these aspects, it is possible to employ alternative vacuum systems, e.g., automated vacuum pump systems. The present filling machine and method can be readily adapted for such uses.

### Exemplifications

Aspects of the filler machine and method of this disclosure will now be described with reference to the accompanying drawings. The drawings and description thereof are provided for the purpose of illustrating specific embodiments and are not intended to limit the invention in any way.

In FIGS. 1A-1C, the empty container (2; exemplified as a bottle) has been inserted into the machine, and sealed by the neck seal (21). The top portion of the container is thereby sealed inside the sealed chamber (5). Prior to filling the container (2) with liquid, the filler tube valve (73) is closed. In this embodiment, the gas injection tube (74) runs inside the filler tube (7). Before liquid filling begins, the filler tube (7) and the gas injection tube (74) are lowered together (as a filler tube assembly) into the container. This lowering is actuated by the filler lifting assembly (700). See, also, FIGS. 10A-10D. The filler tube (7) and the gas injection tube (74) thereby extend to the bottom portion of the container (2). The one or more purge gasses (e.g., carbon dioxide and/or nitrogen) start to flow through the gas injection tube. As shown here, the one or more purge gasses enter at the gas injection port (16) and exit at the bottom portion of the container (2) through the end of the gas injection tube (74).

In FIGS. 2A-2B, the container (2; exemplified as a bottle) has been filled with the liquid product. For filling, the liquid enters into the filler tube (7) via the product port (15), and exits the filler tube (7) through the filler tube valve (73). See, also, FIGS. 5A-5D. The filler tube (7) has been lifted during the filling process such that at the end of filling the filler tube is now located in the upper portion (e.g., neck) of the container (2). At this point, the movement of the filler tube (7) is stopped, the filler tube valve (73) is closed, and the vent valve is closed. No further liquid enters the container. The filler tube (7) (along with the gas injection tube (74)) is then lifted all the way up and out of the container, and the container is ready for capping. It is also possible to repressurise the container before capping/closing with a burst of one or more gases from the secondary injection point.

In FIGS. 3A-3C and 4A-4D, the filler tube (7) and gas injection tube (74) are shown, as are the capping components. Shown, specifically, are the capping station (34), the capper (3), the cap (4), and the cap inserter (30), along with the capper handle (31). The cap (4) is inserted into the machine by the cap inserter (30). For example, the cap inserter (30) can present the cap (4) under the head of the capper (3), and a magnet or other means can hold the cap under the head of the capper (3). The cap (4) can be placed from the head of the capper (3) onto the top of the container (2; exemplified as a bottle) by actuation of the capper handle (31). Some of the seals of the sealed chamber (5) are also shown including the neck seal (21), the filler tube seal (72), and the capper seal (35).

In FIGS. 5A-5D and 6A-6B, the vacuum generator (8) is shown along with the vacuum valve (10), the vent valve (11), and the secondary gas injection port (9). The initial entry point for the liquid into the filler tube (7), i.e., the product port (15), is shown. The initial entry point for the purge gas/gasses into the gas injection tube (74), i.e., the gas injection port (16), is shown. Further to this, the vent exit port (17) is also shown. Additionally, the filler tube valve (73) is shown. This valve opens/seals the filler tube. Shown as well is the filler tube valve controller (70), which controls the filler tube valve (73). The filler tube valve controller (70) is shown as being enclosed in a filler tube controller chamber (71). Here, the filler tube valve controller (70) has been exemplified as a piston.

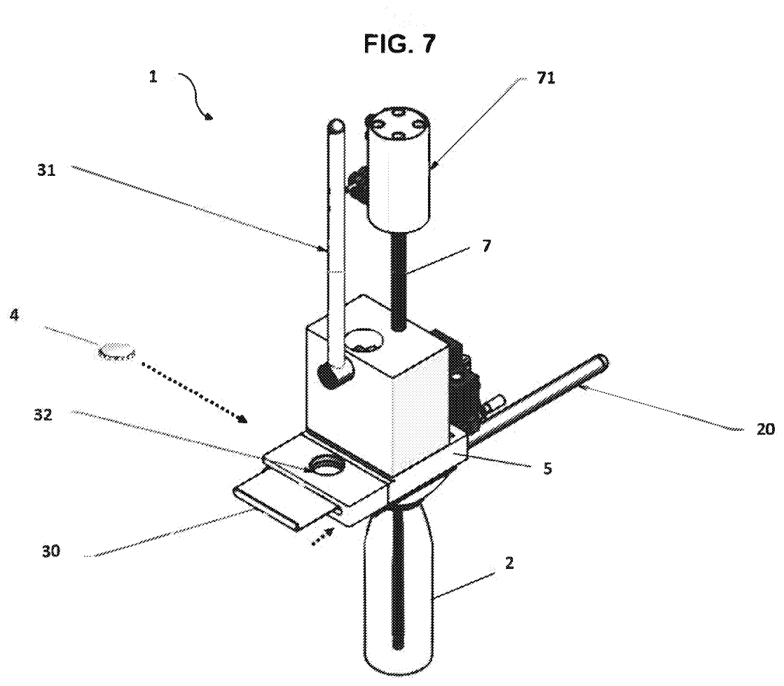

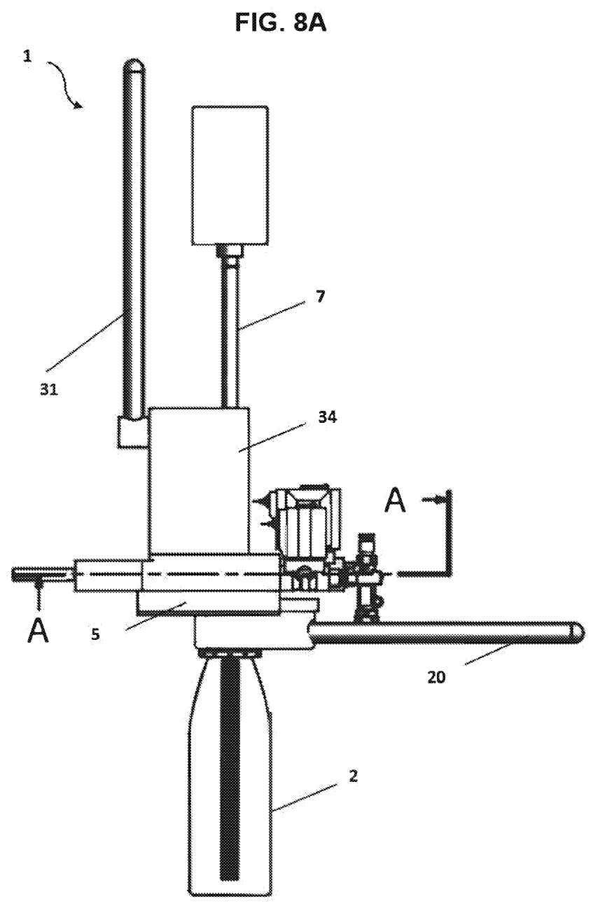

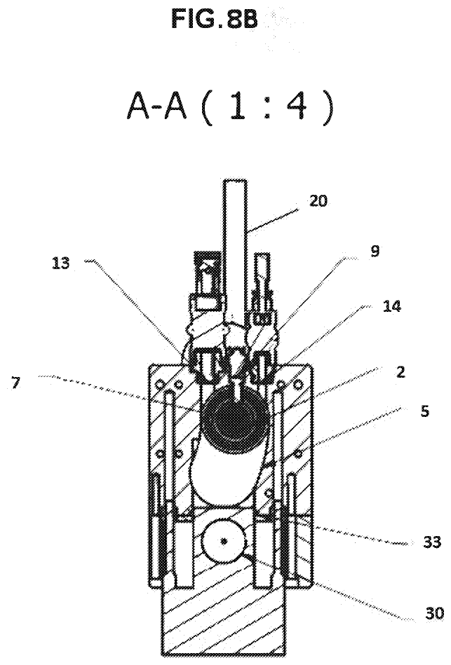

In FIGS. 7 and 8A-8B, the indexing handle (20) is shown. In this exemplification, the indexing handle (20) is used to transfer the container (2; exemplified as a bottle) between the filling and capping positions. In this exemplification, indexing handle (20) is pulled leftwards by the user to shift the container towards the capping/closing station, or the indexing handle (20) is pulled rightwards by the user to shift the container towards the filling station. Details of the vacuum port (13) and vent port (14) are shown. Both the vacuum port (13) and vent port (14) transit to the sealed chamber (5). The cap insert hole (32) is also shown; this is a recess for receiving the cap (4). With the cap (4) in this recess, the cap (4) can be shunted towards the capper (3) using the cap inserter (30). In addition to this, the cap inserter seal (33) is shown. This is part of the sealing arrangement of the sealed chamber (5). Also shown is the capper (31). In this exemplification, the cap (4) is loaded onto the capper (3), and then the capper handle (31) is pulled toward the user to push the cap (4) onto the container (2).

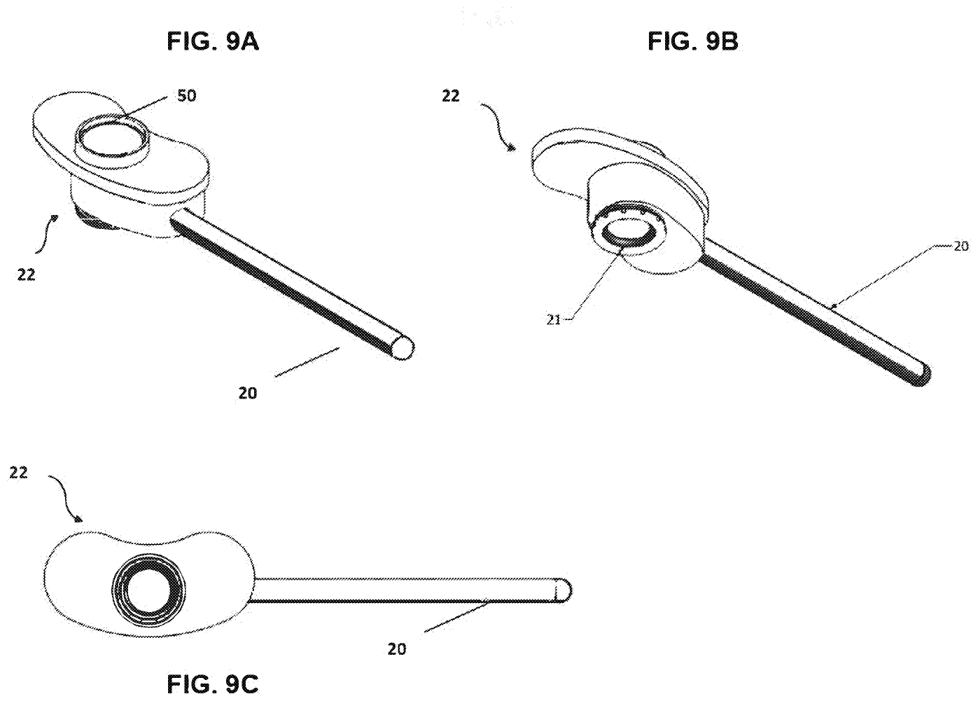

In FIGS. 9A-9C, the filling head assembly (22) is shown. The filling head assembly (22) includes the neck seal (21) and also the indexing handle (20). This handle can be used to move (e.g., rotate) between the fill position and the capping/closure position on the machine. For example, the whole filling head assembly (22) can be designed to rotate on the sealed chamber (5), i.e., rotation is guided on the sealed chamber (5). The top seal (50) seals on the top face of this assembly.

In FIGS. 10A-10D. the filler tube lifter assembly (700) is shown. The filler tube lifter (75), set out here as a pneumatic cylinder. The gas injection tube (74) in this embodiment runs inside the filler tube (7). The filler tube (7) is shown here as being engaged with the lifting mechanism. When the starter (6) is actuated, the lifter (75) is retracted, to move the filler tube (7) downwards. The filler tube valve and vent valve allow liquid to be emptied into the container (2; exemplified as a bottle) via the filler tube (7). The filler tube lifter (75) moves up and this in turn moves up the lifter arm (76). At this point, the container (2) is partially filled with liquid and the lower end of the filler tube (7) is located within the liquid. As the filler tube lifter (75) continues to move in an upward direction, the filler tube lifter (75) continues to move the lifter arm (76) and connector arm (78) upwards in the same upward direction. This movement causes the filler tube (7) to be lifted upwardly in the same direction. Once filling is complete, the lifter (e.g., pneumatic cylinder) may lift to completely remove the filler tube (7) from the container (2). See, also, FIG. 2B.

Because the movement of the filler tube (7) out of the container (2) is linked with movement of the lifter arm (76) and the connector arm (78), the lower end of the filler tube (7), which comprises the filler tube valve (73), will always remain in the liquid in the container (2) during filling. At the end of filling, the lifter arm (76) and the connector arm (78) are back up to the raised position. All of the liquid has been transferred to the container (2), which is now full. The lower end of the filler tube (7) remains in the liquid and then the filler tube valve (73) can be closed. It will therefore be appreciated that as the filler tube (7) moves in an upward direction, the liquid empties into the container (2). At the same time, once the container has been partly filled at that point the filler tube (7) may start moving upwardly out of the container (2). The lower end of the filler tube (7) and the filler tube valve (73) are located within the liquid until filling ceases and the filler tube valve (73) can be closed.

In FIGS. 11A-11D, the filler machine (1) is shown with the container (2; exemplified as a bottle) positioned at the capping/closing station. Shown, in particular, are the capping components, including the capper (3), the cap (4), and the cap inserter (30), along with the capper handle (31). In this embodiment, the cap (4) is inserted into the machine by the capper inserter (30). In particular, the cap (4) can be placed into the cap insert hole (32) and the cap inserter (30) can be pushed towards the capper (3), where the cap (4) engages with the head of the capper (3). The cap (4) can then be transferred from the head of the capper (3) onto the top of the container (2) by actuation of the capper handle (31). Specifically, the capper handle (31) can be pulled towards the user, and the cap (4) thereby pushed onto the mouth of the container (2) (e.g., bottle). The various seals for the sealed chamber (5) are also shown including the neck seal (21), the filler tube seal (72), and the capper seal (35).

Persons of ordinary skill can utilise the disclosures and teachings herein to produce other embodiments and variations without undue experimentation. All such embodiments and variations are considered to be part of this invention.

Accordingly, one of ordinary skill in the art will readily appreciate from the disclosure that later modifications, substitutions, and/or variations performing substantially the same function or achieving substantially the same result as embodiments described herein may be utilised according to such related embodiments of the present invention. Thus, the invention is intended to encompass, within its scope, the modifications, substitutions, and variations to processes, manufactures, compositions of matter, compounds, means, methods, and/or steps disclosed herein.

In this specification, where reference has been made to external sources of information, including patent specifications and other documents, this is generally for the purpose of providing a context for discussing the features of the present invention. Unless stated otherwise, reference to such sources of information is not to be construed, in any jurisdiction, as an admission that such sources of information are prior art or form part of the common general knowledge in the art.

The description herein may contain subject matter that falls outside of the scope of the claimed invention. This subject matter is included to aid understanding of the invention.

1. A filler machine comprising:
a sealed chamber which seals off air entry to (i) a container or a container opening, (ii) a cap or other closure for the container, and (iii) a capper or other closure-adding mechanism which introduces the cap or the other closure, respectively, to the container opening, the sealed chamber being connected to a vacuum generating mechanism and a vent valve;
a filler tube which introduces liquid into the container, which is lowered into the container, and which extends through the sealed chamber via sealed entry, wherein (i) prior to filling the container with the liquid, the filler tube is positioned at or proximate the bottom of the container, (ii) during filling, the filler tube lifts while still keeping a bottom end of the filler tube immersed in the liquid, and (iii) on completion of filling, the filler tube is lifted out of the container;
a filler tube lifting assembly which lowers the filler tube into the container and lifts the filler tube during filling; and lifts the filler tube out of the container on completion of filling;
a gas injection tube which runs parallel or essentially parallel to the filler tube, which directs one or more purge gases into the container prior to the liquid being filled into the container, and which is lifted and lowered into the container together with the filler tube;
the vacuum generating mechanism which draws air and the one or more purge gasses out of the container and sealed chamber through a top portion of the sealed chamber prior to the liquid being filled in the container, wherein the vacuum generating mechanism thereby assists with purging of air from the container and the sealed chamber;
a secondary gas injection mechanism which directs one or more secondary gasses into a top portion of the sealed chamber prior to and during the filling of the container with the liquid, wherein the secondary gas injection mechanism thereby restores pressure to the container that is lost during filling of the liquid in the container; and
the vent valve which has an opening in an exit port to control release of pressure from within the container, which in turn controls flow of liquid into the container.

2. The filler machine of claim 1, wherein the container is a bottle or a can.

3. (canceled)

4. The filler machine of claim 1, wherein the cap is a crown cap, a screw cap or a can lid.

5-7. (canceled)

8. The filler machine of claim 1, wherein the vacuum generating mechanism is a pneumatic vacuum generator.

9. The filler machine of claim 1, wherein the gas injection tube is positioned inside the filler tube.

10. The filler machine of claim 1, wherein the gas injection tube is positioned externally to and proximal to the filler tube.

11. The filler machine of claim 1, wherein the liquid enters the filler tube through a product port, which is positioned at a top portion of the filler tube.

12. The filler machine of claim 1, wherein the one or more purge gases enter the gas injection tube through a gas injection port, which is positioned at a top portion of the gas injection tube.

13. The filler machine of claim 1, wherein the one or more purge gases are selected from carbon dioxide, nitrogen, and a combination thereof.

14. The filler machine of claim 1, wherein the one or more secondary gases are selected from carbon dioxide, nitrogen, and a combination thereof.

15. The filler machine of claim 1, wherein the filler machine further includes a filler tube piston at a top portion of the filler tube.

16. The filler machine of claim 1, wherein the filler tube piston controls a filler tube valve which opens and closes at the bottom portion of the filler tube.

17. The filler machine of claim 1, wherein the filler machine further includes an indexing handle to transit a filling head assembly from a fill position to a cap/closure position on the filler machine, wherein the filling head assembly allows the container to remain sealed off from air entry during shifting of the container between the fill position and the cap/closure position on the filler machine.

18. The filler machine of claim 1, wherein the filler machine further includes a capping/closing assembly to cap or otherwise close the container which has been filled with the liquid, wherein the capping/closing assembly allows for the container to remain sealed off from air entry during capping or otherwise closing of the container.

19-20. (canceled)

21. A method of filling a container with liquid, the method comprising:
placing a container, or a neck and an opening of the container, into a chamber which seals off air entry to (i) the container or the opening of the container, (ii) a cap or other closure for the container, and (iii) a capper or other closure-adding mechanism which places the cap or the other closure, respectively, onto the opening of the container;
injecting one or more purge gases through a gas injection tube, the gas injection tube running parallel or essentially parallel to a filler tube and being movable together with the filler tube, and lowering the gas injection tube along with the filler tube into the container, the filler tube and the gas injection tube extending through the chamber, and the filler tube and the gas injection tube being lowered such that a bottom of the filler tube and a bottom of the gas injection tube is positioned at or proximate the bottom of the container;
generating a vacuum to draw air and the one or more purge gasses out of the container and the chamber through an upper portion of the chamber;
pressurising the container and the chamber by injecting one or more secondary gases;
commencing filling of the container by transiting the liquid through the filler tube and into the container;
during filling (i) lifting the filler tube while still keeping a bottom end of the filler tube immersed in the liquid, (ii) injecting one or more further secondary gases into a top portion of the chamber to maintain pressure in the container, and (iii) using venting on the chamber to control the filling;
on completion of filling, lifting the filler tube and the gas injection tube out of the container to allow introduction of the cap or other closure to the container.

22-27. (canceled)

28. The method of claim 21, wherein the gas injection tube is positioned inside the filler tube.

29. The method of claim 21, wherein the gas injection tube is positioned externally to and proximal to the filler tube.

30. (canceled)

31. (canceled)

32. The method of claim 21, wherein for the pressurising, the one or more secondary gases are injected through the gas injection tube or a secondary gas port or a combination thereof.

33. The method of claim 21, wherein the method further comprises transiting the container which has been filled with the liquid to a position on the machine for capping or otherwise closing the container, wherein the container is still sealed off from air entry while transiting to the position for the capping or the otherwise closing of the container.

34. The method of claim 21, wherein the method further comprises capping or otherwise closing the container which has been filled with the liquid, wherein the container is still sealed off from air entry during the capping or the otherwise closing of the container.

35-39. (canceled)
